(19) United States
(12) Patent Application Publication
(10) Pub. No.: US 2026/0146415 A1
(43) Pub. Date: May 28, 2026

(54) VALIDATION OF PERCEPTION INFORMATION OBTAINED BY A PERCEPTION SENSOR SYSTEM THAT INCLUDES A PLURALITY OF SENSORS

(71) Applicant: Caterpillar Inc., Peoria, IL (US)

(72) Inventors: Darren Allan BLUM, Plainfield, IL (US); Michael Anthony SPIELMAN, JR., Osseo, MI (US); Shaun D. CURRIER, Naperville, IL (US); Tonglin SHANG, Bolingbrook, IL (US); Aleksandar M. EGELJA, Naperville, IL (US); Aleksander Franklin GUST, Orland Park, IL (US); Jeffrey Kent BERRY, Yorkville, IL (US)

(73) Assignee: Caterpillar Inc., Peoria, IL (US)

(21) Appl. No.: 18/961,818

(22) Filed: Nov. 27, 2024

(51) Int. Cl. E02F 9/26; G01S 13/08

(52) U.S. Cl. CPC E02F 9/261; G01S 13/08

(57) ABSTRACT

A controller may obtain perception information from a perception sensor system of the machine that includes a plurality of sensors, wherein the perception information includes respective perception data captured by the plurality of sensors. The controller may determine validity information associated with the perception information. The controller may select, based on the validity information, a portion of the perception information. The controller may determine, based on the portion of the perception information, a current distance to a target.

### TECHNICAL FIELD

The present disclosure relates generally to a machine and, for example, to validation of perception information obtained by a perception sensor system of the machine that includes a plurality of sensors.

### BACKGROUND

To perform a dumping operation, a machine, such as a wheel loader, can use an implement (e.g., a bucket or another implement) to load and to carry a material (e.g., asphalt, debris, dirt, snow, feed, gravel, logs, raw minerals, recycled material, rock, sand, woodchips, or similar material) and to dump the material into a dump target (e.g., another machine, such as a dump truck). The machine can include a plurality of sensors to detect a distance (e.g., a representative distance of a plurality of individually detected distances) from the machine to the dump target, such as to enable an automated implement lift operation. For example, the machine can use the plurality of sensors to identify when the machine is sufficiently near to the dump target, and thereby automatically cause the implement to raise to a dumping height to enable an efficient dumping of material from the implement into the dump target as soon as the machine reaches the dump target.

However, many factors can impact an ability of a sensor to accurately detect an individual distance to the dump target, such as environmental factors (e.g., factors related to weather conditions, lighting conditions, and/or worksite conditions), sensor factors (e.g., factors related to field of view capabilities, resolution capabilities, detection speed capabilities, range capabilities, calibration issues, sensor fouling issues, and/or interference conditions with other

sensors and/or other electric equipment), target factors (e.g., factors related to detectability of a size of the dump target, a geometry of the dump target, fouling of the dump target, and/or a material of the dump target), and machine factors (e.g., factors related to vibration and/or movement of the machine and/or the implement and a linkage that connects the implement to the machine, such as obstruction of a field of view of a sensor due to a position of the implement and the linkage). Consequently, in many cases, the machine uses inaccurate sensor readings from one or more sensors, which inhibits an ability of the machine to accurately determine a distance to the dump target. In many cases, this can result in the machine unintentionally contacting the dump target, such as due to a miscalculation of a stopping distance or of an implement position with respect to the dump target. This, in turn, causes damage (e.g., dents, cracks, or other types of structural deformations) to the implement and the linkage, the machine, and the dump target. This can impact a performance of, as well as reduce an operable life of, the implement and the linkage, the machine, and the dump target.

The controller of the present disclosure solves one or more of the problems set forth above and/or other problems in the art.

### SUMMARY

A machine comprises: an implement and a linkage; a perception sensor system that includes a plurality of sensors; a machine sensor system that includes a plurality of other sensors; and a controller configured to: identify a previously determined distance to a target; obtain machine information from the machine sensor system; determine, based on the machine information, a position of the implement and the linkage and a steering angle of the machine; obtain perception information from the perception sensor system, wherein the perception information includes respective perception data captured by the plurality of sensors; determine, based on at least one of the previously determined distance to the target, the position of the implement and the linkage, or the steering angle of the machine, validity information associated with the perception information; select, based on the validity information, a portion of the perception information; and determine, based on the portion of the perception information, a current distance to the target.

A controller of a machine includes one or more memories; and one or more processors, coupled to the one or more memories, configured to: identify a previously determined distance to a target; obtain machine information from a machine sensor system of the machine; obtain perception information from a perception sensor system of the machine that includes a plurality of sensors; determine, based on at least one of the previously determined distance to the target or the machine information, validity information associated with the perception information; select, based on the validity information, a portion of the perception information; and determine, based on the portion of the perception information, a current distance to the target.

A method includes obtaining, by a controller of a machine, perception information from a perception sensor system of the machine that includes a plurality of sensors, wherein the perception information includes respective perception data captured by the plurality of sensors; determining, by the controller, validity information associated with the perception information; selecting, by the controller, based on the validity information, a portion of the perception information; and determining, by the controller, based on the portion of the perception information, a current distance to a target.

### BRIEF DESCRIPTION OF THE DRAWINGS

FIG. 1 is a diagram of an example machine described herein.

FIG. 2 is a diagram of an example configuration of the front of the machine.

FIGS. 3A-3B are diagrams of an example implementation described herein.

FIGS. 4A-4B are diagrams of an example implementation described herein.

FIG. 5 is a diagram of example components of a device associated with validation of perception information obtained by a perception sensor system that includes a plurality of sensors.

### DETAILED DESCRIPTION

This disclosure relates to a controller of a machine (e.g., that performs a dumping operation) and is applicable to any machine that is capable of loading and moving material (e.g., from a first location to a second, different location) and/or dumping the material (e.g., into a dump target). For example, the machine may be any machine that performs an operation associated with an industry such as, for example, mining, construction, farming, transportation, or any other industry. As some examples, the machine may be a vehicle, a wheel loader, a backhoe loader, a cold planer, a compactor, a feller buncher, a forest machine, a forwarder, a harvester, an excavator, an industrial loader, a knuckleboom loader, a material handler, a motor grader, a pipelayer, a road reclaimer, a skid steer loader, a tractor, a dozer, a tractor scraper, or other above ground equipment, underground equipment, aerial equipment, or marine equipment.

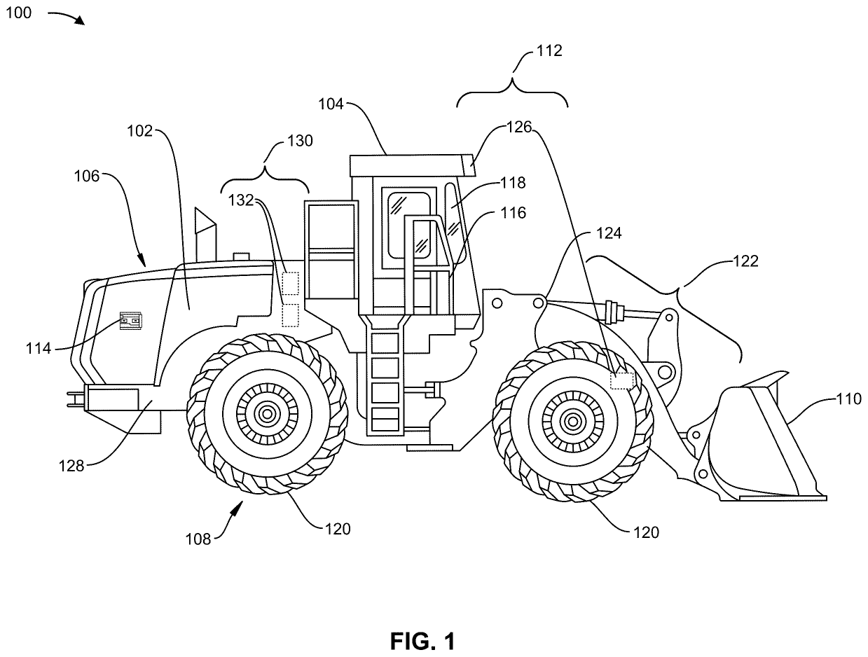

FIG. 1 is a diagram of an example machine 100 described herein. For example, the machine 100 may include a mobile machine, such as the wheel loader shown in Fig. l, or any other type of mobile machine. Further, the machine 100 may be a manned machine or an unmanned machine, and/or may be fully autonomous, semi-autonomous, or remotely operated.

As shown, the machine 100 may have a frame 102 that supports an operator station 104, a power system 106, a drive system 108, an implement 110, a perception sensor system 112, and a controller 114. The operator station 104 may include operator controls 116 for operating the machine 100 via the power system 106. In some examples, the machine 100 may not include an operator station 104 and/or operator controls 116 (e.g., the machine 100 may be controlled via other means, such as a remote control system). The operator station 104 may be configured to define an interior cabin 118 within which the operator controls 116 are housed.

The power system 106 is configured to supply power to the machine 100. The power system 106 may be operably arranged to receive control signals from the operator controls 116 in the operator station 104 and/or from the controller 114. Additionally, or alternatively, the power system 106 may be operably arranged with the drive system 108 and/or the implement 110 to selectively operate the drive system 108 and/or the implement 110 according to the control signals. The power system 106 may provide operating power for the propulsion of the drive system 108 and/or the operation of the implement 110. The power system 106 may include an engine, a motor, an electric drive, a fuel cell, and/or another type of power system.

The drive system 108 may be operably arranged with the power system 106 to selectively propel the machine 100 via the control signals. The drive system 108 can include a plurality of ground-engaging members, such as wheels 120, as shown, which can be movably connected to the frame 102 through axles, drive shafts, and/or other components. The drive system 108 may be provided in the form of a track-drive system, a wheel-drive system, or any other type of drive system configured to propel the machine 100.

The implement 110 may be operably arranged with the power system 106 such that the implement 110 is selectively movable through control signals transmitted to the power system 106 from the operator controls 116 and/or the controller 114. As shown in FIG. 1, the implement 110 may be coupled to the machine 100 via a linkage 122, such as at a front 124 of the machine 100. The implement 110 may also be referred to as an attachment, a work tool, a work implement, and/or a tool, among other examples. FIG. 1 depicts implement 110 as a bucket as an example. Other embodiments can include any other suitable implement 110 for a variety of tasks, including, for example, dozing, brushing, compacting, grading, lifting, loading, plowing, and/or ripping, among other examples. Example implements 110 include a stump grinder, a trencher, a broom, a brush cutter, a cold planer, a mower, a mulcher, a processor, a pulverizer, a rake, a saw, a snow product, a snow blower, a tiller, a winch, an auger, a blade, a breaker/hammer, a compactor, a cutter, a forked lifting device, a grader bit and end bit, a grapple, a blade, and/or a ripper, among other examples. As described elsewhere herein, the implement 110 may include one or more components or parts that are electrically powered.

The perception sensor system 112 includes a plurality of sensors 126, which may be coupled to the machine 100, such as at the front 124 of the machine 100. The plurality of sensors 126 may include a sonar sensor, a camera, a light detection and raging (LIDAR) sensor, and/or a radio detection and ranging (RADAR) sensor, or another type of sensor to perceive an environment of the machine 100. That is, the plurality of sensors 126 may include at least one sensor that is configured to capture perception data that can be used (e.g., by the controller 114) to determine at least one of a distance to a target (e.g., a dump target) or a height of the target.

The controller 114 may include an electronic control module (ECM) or other computing device. The controller 114 may be configured to cause perception data captured by sets of one or more sensors of the perception sensor system 112 to be used in association with an automatic control operation associated with at least one of the machine 100 or the implement 110 and the linkage 122, cause an automatic perception zone calibration operation to be performed (e.g., in association with the perception sensor system 112), and/or cause one or more other actions to be performed, as further described herein.

A rear portion 128 of the machine 100 may include an engine and a transmission. The engine may be any type of engine suitable for performing work using the machine 100, such as an internal combustion engine, a diesel engine, a gasoline engine, a gaseous fuel-powered engine, and/or the like. In other examples, rather than an engine, the machine 100 may include another power system, such as a motor (e.g., an electric motor), a battery powered system, a fuel cell, or another type of power system. The transmission may transfer power from the engine to the drive system 108 and/or the implement 110.

The machine may include a machine sensor system 130 that includes a plurality of other sensors 132, which may be housed within the machine 100. The plurality of other sensors 132 may include a location sensor (e.g., a global positioning system (GPS) sensor, or a local positioning system sensor) configured to determine a physical location of the machine 100, a position sensor (e.g., a rotation sensor, or another sensor) configured to detect a position of the implement 110 and the linkage 122, a speed sensor configured to determine a speed of the machine 100 (e.g., when travelling over a surface), a steering angle sensor configured to determine a steering angle of the machine 100, and/or one or more other sensors.

As indicated above, FIG. 1 is provided as an example. Other examples may differ from what is described in connection with FIG. 1.

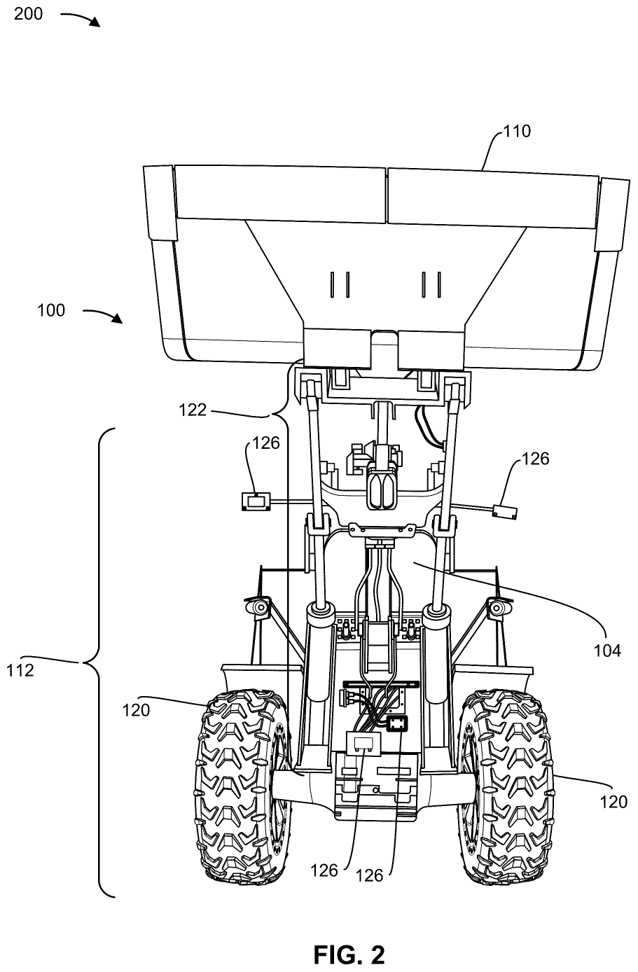

FIG. 2 is a diagram of an example configuration 200 of the front 124 of the machine 100 (e.g., when the implement 110 and the linkage 122 are extended to a “high” position, as further described herein). The perception sensor system 112 may include a plurality of sensors 126 that are positioned at different locations (e.g., on the machine 100, at the front 124 of the machine 100). For example, as shown in FIG. 2, one or more sensors 126 may be positioned at a first height associated with (e.g., aligned with, or nearly aligned with) a top of the operator station and one or more sensors 126 may be positioned at a second height associated with (e.g., aligned with, or nearly aligned with) the wheels 120.

As indicated above, FIG. 2 is provided as an example. Other examples may differ from what is described in connection with FIG. 2.

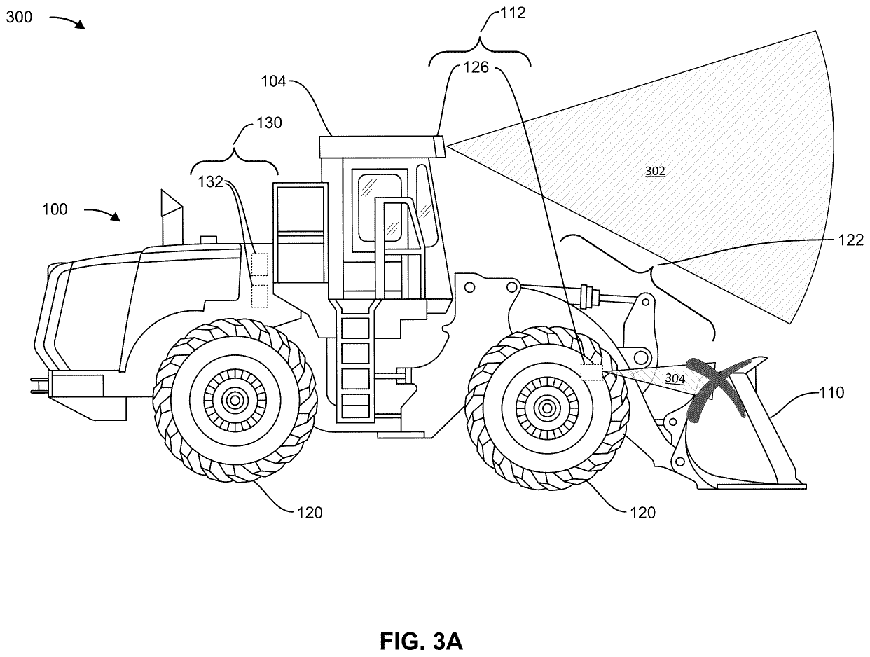

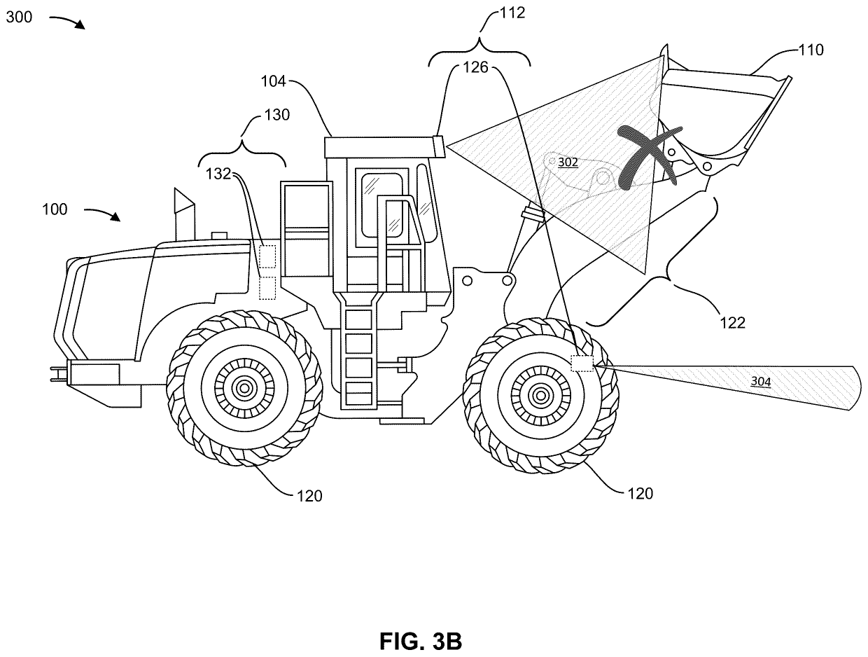

FIGS. 3A-3B are diagrams of an example implementation 300 described herein. FIGS. 3A-3B show side views of the machine 100 when the implement 110 and the linkage 122 are in different positions.

As shown in FIG. 3A, the implement 110 and the linkage 122 may be in a “low” position (e.g., where the implement 110 is aligned with, or nearly aligned with, the wheels 120). As part of an automatic control operation (e.g., that is associated with at least one of the machine 100 or the implement 110 and the linkage 122), the controller 114 may cause the implement 110 and the linkage 122 to be in the low position. For example, as part of the automatic control operation, the controller 114 may cause (e.g., when the machine 100 is traveling, such as in a forward direction) the implement 110 and the linkage 122 to be in the low position to enable loading and/or carrying of material, such as from a first location to a second location that is associated with a dump target (e.g., another machine, such as a dump truck). As shown in FIG. 3A, when in the low position, the implement 110 and the linkage 122 may not obstruct a field of view 302 of a first sensor 126 of the perception sensor system 112, and may obstruct a field of view 304 of a second sensor 126 of the perception sensor system 112.

As shown in FIG. 3B, the implement 110 and the linkage 122 may be in a “high” position (e.g., where the implement 110 is aligned with, or nearly aligned with, a top of the operator station 104). As part of the automatic control operation, the controller 114 may cause the implement 110 and the linkage 122 to be in the high position. For example, as part of the automatic control operation, the controller 114 may cause (e.g., when the machine 100 is traveling, such as in a forward direction) the implement 110 and the linkage 122 to be in the high position when the machine 100 is within a “dumping distance” (e.g., within a threshold distance) of the dump target (e.g., to facilitate an impending dumping of the material carried by the implement 110). As shown in FIG. 3B, when in the high position, the implement 110 and the linkage 122 may obstruct the field of view 302 of the first sensor 126 of the perception sensor system 112, and may not obstruct the field of view 304 of the second sensor 126 of the perception sensor system 112.

As indicated above, FIGS. 3A-3B are provided as an example. Other examples may differ from what is described in connection with FIGS. 3A-3B.

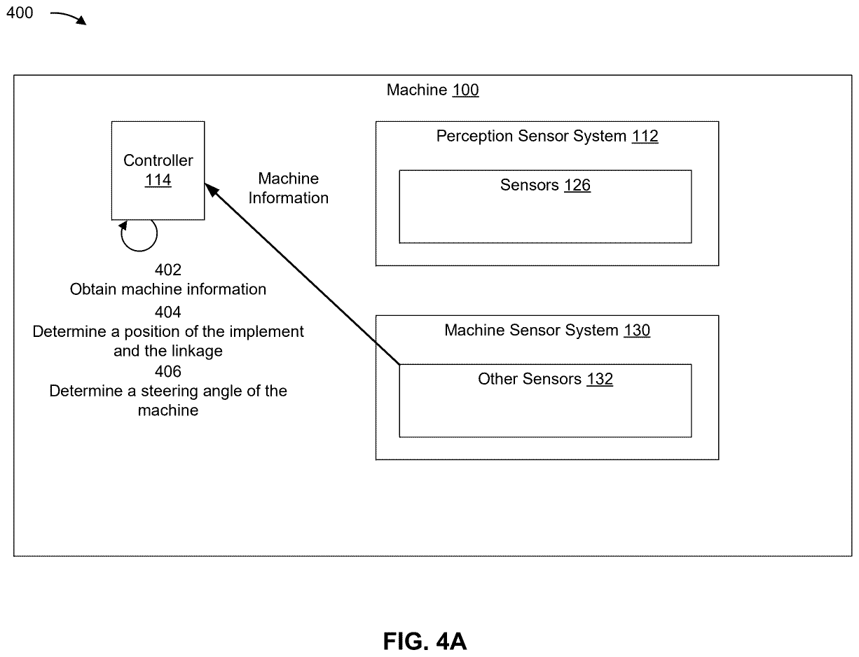

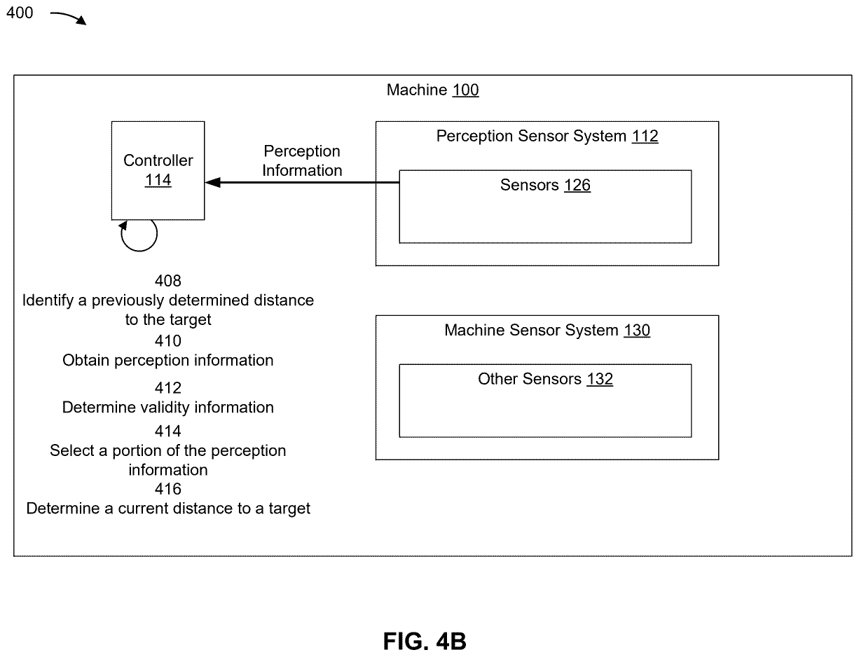

FIGS. 4A-4B are diagrams of an example implementation 400 described herein. FIGS. 4A-4B show how the controller 114 determines a current distance to a target, such as based on validation of perception information obtained by the perception sensor system 112 (e.g., that includes the plurality of sensors 126).

As shown in FIG. 4A, and by reference number 402, the controller 114 may obtain machine information. For example, the controller 114 may obtain the machine information from the machine sensor system 130 (e.g., from the plurality of other sensors 132 of the machine sensor system 130). The machine information may include respective machine data captured by the plurality of other sensors 132. That is, each other sensor 132, of the plurality of other sensors 132, may send machine data that is captured by the other sensor 132 to the controller 114 (e.g., in real time, or near real time), and therefore the controller 114 may collectively receive respective machine data captured by the plurality of other sensors 132 as machine information.

As shown by reference number 404, the controller 114 may determine a position of the implement 110 and the linkage 122. For example, when the plurality of other sensors 132 includes a position sensor, the controller 114 may receive machine data from the position sensor (e.g., in real time, or near real time) that indicates the position of the implement 110 and the linkage 122. The controller 114 may process (e.g., parse and/or read, along with other examples) the machine data to determine that the implement 110 and the linkage 122 are in the position. The implement 110 and the linkage 122 may be in the position, for example, to load and/or carry material, such as from a first location to a second location that is associated with a dump target (e.g., another machine, such as a dump truck). The position may be, for example, the low position or the high position, described herein in relation to FIGS. 3A-3B, or another position.

As shown by reference number 406, the controller 114 may determine a steering angle of the machine 100. For example, when the plurality of other sensors 132 includes a steering angle sensor, the controller 114 may receive machine data from the steering angle sensor (e.g., in real time, or near real time) that indicates the steering angle of the machine 100. The controller 114 then may process (e.g., parse and/or read, along with other examples) the machine data to determine the steering angle of the machine 100. The machine 100 may have the steering angle as a result of an operator of the machine 100 interacting with the operator controls 116 to cause the machine to head in a particular direction (e.g., when travelling), such as to a target (e.g., the dump target).

As shown in FIG. 4B, and by reference number 408, the controller 114 may identify a previously determined distance to the target. The previously determined distance may have been determined by the controller 114. For example, the controller 114 may perform some or all of the operations described herein in relation to FIGS. 4A-4B in repeating loops, and therefore the controller 114 may have previously determined a distance to the target (e.g., as further described herein in relation to FIG. 4B) when performing a previous loop. Accordingly, after completion of the previous loop, the controller 114 may identify the distance as a previously determined distance to the target.

As shown by reference number 410, the controller 114 may obtain perception information. For example, the controller 114 may obtain the perception information from the perception sensor system 112 (e.g., from the plurality of sensors 126 of the perception sensor system 112). The perception information may include respective perception data captured by the plurality of sensors 126. That is, each sensor 126, of the plurality of sensors 126, may send perception data that is captured by the sensor 126 to the controller 114 (e.g., in real time, or near real time), and therefore the controller 114 may collectively receive respective perception data captured by the plurality of sensors 126 as perception information.

As shown by reference number 412, the controller 114 may determine validity information associated with the perception information. The validity information may indicate, for each sensor 126 of the plurality of sensors 126, whether perception data that is captured by the sensor 126 (and that is included in the perception information) is valid. That is, the validity information may indicate whether the perception data is sufficiently accurate to be used as a basis for determining a current distance to the target (e.g., as further described herein).

The controller 114 may determine the validity information based on at least one of the previously determined distance to the target or the machine information. In some implementations, the controller 114 may determine the validity information based on at least one of the previously determined distance to the target, the position of the implement 110 and the linkage 122, or the steering angle of the machine 100.

As an example, to determine the validity information, the controller 114 may identify perception data, of the perception information, that is captured by a sensor 126 (e.g., a particular sensor 126) of the plurality of sensors 126. Accordingly, the controller 114 may determine (e.g., based on the perception data) a perceived distance to the target. For example, the controller 114 may process (e.g., parse and/or read, along with other examples) the perception data to determine the perceived distance to the target (e.g., a distance as perceived by the sensor 126 that captured the perception data). Accordingly, the controller 114 may determine distance difference information associated with the perceived distance to the target.

To determine the distance difference information, as an example, the controller 114 may determine a distance difference (e.g., a first distance difference) between the perceived distance and the previously determined distance to the target (e.g., that was identified by the controller 114, as described herein in relation to reference number 408). As another example, to determine the distance difference information, the controller 114 may identify a previously determined perceived distance to the target (e.g., that was determined based on previously captured perception data by the sensor 126) and may determine a distance difference (e.g., a second distance difference) between the perceived distance and the previously determined perceived distance. In an additional example, to determine the distance difference information, the controller 114 may determine, based on other perception data, of the perception information, that is captured, respectively, by one or more other sensors 126 of the plurality of sensors 126, one or more other perceived distances to the target, and may determine respective distance differences (e.g., respective third distance differences) between the perceived distance and the one or more other perceived distances. Accordingly, the distance information my indicate at least one of the first distance difference, the second distance difference, or the respective third distance differences.

The controller 114 then may determine whether the perception data is valid based on the distance difference information. For example, the controller 114 may determine whether the perception data is valid based on at least one of the first distance difference, the second distance difference, or the respective third distance differences. The controller 114 may determine that the first distance difference, the second distance difference, and/or the respective third distance differences satisfy (e.g., are less than) a distance difference threshold to determine that the perception data is valid. That is, the controller 114 may determine that the perception data is valid based on the perceived distance and the previously determined distance to the target (e.g., as represented by the first distance difference) being sufficiently similar, which indicates that the perceived distance is likely accurate; based on the perceived distance and the previously determined perceived distance to the target (e.g., as represented by the second distance difference) being sufficiently similar, which indicates that the perceived distance is likely accurate; and/or based on the perceived distance and the one or more other perceived distances to the target (e.g., as represented by the respective third distances) being sufficiently similar, which indicates that the perceived distance is likely accurate. Accordingly, the controller 114 may cause the validity information to indicate that the perception data is valid. Alternatively, the controller 114 may determine that at least one of the first distance difference, the second distance difference, or the respective third distance differences do not satisfy (e.g., are greater than or equal to) the distance difference threshold (or a different difference threshold) to determine that the perception data is not valid. That is, the controller 114 may determine that the perception data is not valid based on the perceived distance and the previously determined distance to the target (e.g., as represented by the first distance difference) not being sufficiently similar, which indicates that the perceived distance is likely not accurate; based on the perceived distance and the previously determined perceived distance to the target (e.g., as represented by the second distance difference) not being sufficiently similar, which indicates that the perceived distance is likely not accurate; and/or based on the perceived distance and the one or more other perceived distances to the target (e.g., as represented by the respective third distances) not being sufficiently similar, which indicates that the perceived distance is likely not accurate. Accordingly, the controller 114 may cause the validity information to indicate that the perception data is not valid.

In another example, to determine the validity information, the controller 114 may identify perception data, of the perception information, that is captured by a sensor 126 (e.g., a particular sensor 126) of the plurality of sensors 126. The controller 114 may also determine whether a field of view of the sensor 126 is obstructed. For example, the controller 114 may determine, based on the position of the implement 110 and the linkage 122 (e.g., as indicated by the machine information), whether the field of view of the sensor 126 is obstructed by the implement 110 and the linkage 122. As a specific example, with respect to FIG. 3A, when the position of the implement 110 and the linkage 122 is the low position, the implement 110 and the linkage 122 may not obstruct a field of view 302 of a first sensor 126 of the perception sensor system 112, and may obstruct a field of view 304 of a second sensor 126 of the perception sensor system 112. Accordingly, the controller 114 may determine, based on the low position of the implement 110 and the linkage 122, that the field of view 302 of the first sensor 126 is obstructed and that the field of view 304 of the second sensor 126 is not obstructed.

Accordingly, the controller 114 may determine whether the perception data is valid (e.g., based on determining whether the field of view of the sensor 126 is obstructed). The controller 114 may determine that the perception data is valid based on determining that the field of view of the sensor 126 is not obstructed. That is, the controller 114 may determine that the sensor 126 has an open field of detection, which indicates that the perceived distance is likely accurate. Accordingly, the controller 114 may cause the validity information to indicate that the perception data is valid. Alternatively, the controller 114 may determine that the perception data is not valid based on determining that the field of view of the sensor 126 is obstructed. That is, the controller 114 may determine that the sensor 126 does not have an open field of detection, which indicates that the perceived distance is likely not accurate. Accordingly, the controller 114 may cause the validity information to indicate that the perception data is not valid.

In an additional example, to determine the validity information, the controller 114 may identify perception data, of the perception information, that is captured by a sensor 126 (e.g., a particular sensor 126) of the plurality of sensors 126. The controller 114 may also identify a first instant in time associated with the previously determined distance (e.g., as described herein in relation to reference number 408), such as an instant in time when determination of the previously determined distance was initiated or was completed, and may identify a second instant in time associated with the perception data, such as an instant in time when the sensor 126 captured the perception data or an instant in time when the controller 114 obtained the perception data. Accordingly, the controller 114 may determine whether the perception data is valid based on the first instant in time and the second instant in time. For example, the controller 114 may determine whether the second instant in time occurred after the first instant in time. That is, the controller 114 may determine whether the sensor 126 captured, or the controller 114 obtained, the perception data after determination of the previously determined distance, which may indicate whether the perception data is fresh or stale.

Accordingly, the controller 114 may determine whether the perception data is valid (e.g., based on determining whether the second instant in time occurred after the first instant in time). The controller 114 may determine that the perception data is valid based on determining that the second instant in time occurred after the first instant in time. That is, the controller 114 may determine that the perception data is fresh, which indicates that the perceived distance is likely accurate. Accordingly, the controller 114 may cause the validity information to indicate that the perception data is valid. Alternatively, the controller 114 may determine that the perception data is not valid based on determining that the second instant in time did not occur after the first instant in time. That is, the controller 114 may determine that the perception data is stale, which indicates that the perceived distance is likely not accurate. Accordingly, the controller 114 may cause the validity information to indicate that the perception data is not valid.

In another example, to determine the validity information, the controller 114 may identify perception data, of the perception information, that is captured by a sensor 126 (e.g., a particular sensor 126) of the plurality of sensors 126. The controller 114 may also determine whether the perception data is associated with a projected path of the machine 100. For example, the controller 114 may determine, based on the steering angle of the machine 100 (e.g., as described herein in relation to FIG. 4A and the reference number 406), a projected path of the machine 100, and may determine whether the projected path is within a field of view of the sensor 126. The controller 114 may determine that the perception data is associated with the projected path based on determining that the projected path is within the field of view of the sensor 126, and, alternatively, may determine that the perception data is not associated with the projected path based on determining that the projected path is not within the field of view of the sensor 126.

Accordingly, the controller 114 may determine whether the perception data is valid (e.g., based on determining whether the perception data is associated with the projected path). The controller 114 may determine that the perception data is valid based on determining that the perception data is associated with the projected path. That is, the controller 114 may determine that the perception data is associated with the projected path, which indicates that the perceived distance is likely accurate. Accordingly, the controller 114 may cause the validity information to indicate that the perception data is valid. Alternatively, the controller 114 may determine that the perception data is not valid based on determining that the perception data is not associated with the projected path. That is, the controller 114 may determine that the perception data is not associated with the projected path, which indicates that the perceived distance is likely not accurate. Accordingly, the controller 114 may cause the validity information to indicate that the perception data is not valid.

As further shown in FIG. 4B, and by reference number 414, the controller 114 may select a portion of the perception information (e.g., based on the validity information). For example, the controller 114 may identify a first portion of the perception information that includes perception data that the validity information indicates is valid, and may identify a second portion of the perception information that includes perception data that the validity information indicates is not valid. Accordingly, the controller 114 may select the first portion of the perception information. That is, the controller 114 may select a portion of the perception information that includes valid perception data (e.g., as indicated by the validity information).

As shown by reference number 416, the controller 114 may determine a current distance to the target (e.g., based on the portion of the perception information). For example, the controller 114 may process the portion of the perception information (e.g. using one or more analysis techniques, such as an analysis technique that uses a Kalman filter or another time-series analysis technique) to determine the current distance to the target. In some implementations, the portion of the perception information may include respective perception data captured by at least some of the plurality of sensors 126. Accordingly, the current distance to the target may be a representative distance to the target of the plurality of sensors 126, where the representative distance is a fused distance (e.g., an average, or another type of integration or merging) of distances associated with valid perception data captured by the plurality of sensors 126.

As indicated above, FIGS. 4A-4B are provided as an example. Other examples may differ from what is described in connection with FIGS. 4A-4B.

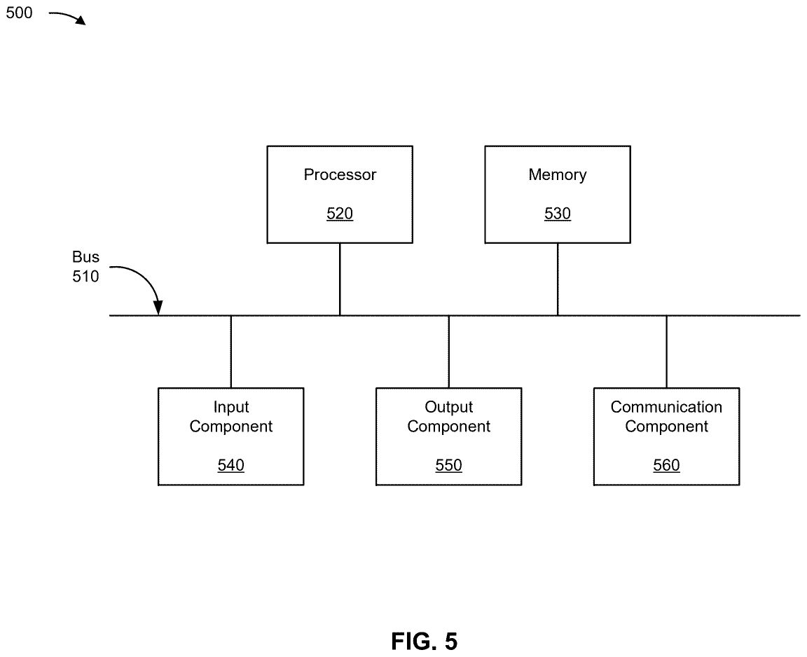

FIG. 5 is a diagram of example components of a device 500 associated with validation of perception information obtained by a perception sensor system that includes a plurality of sensors. The device 500 may correspond to the perception sensor system 112, the controller 114, the plurality of sensors 126, the machine sensor system 130, and/or the plurality of other sensors 132. The perception sensor system 112, the controller 114, the plurality of sensors 126, the machine sensor system 130, and/or the plurality of other sensors 132 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. The processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. The memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. Execution of the set of instructions, by one or more processors 520, causes the one or more processors 520 and/or the device 500 to perform one or more operations or processes described herein. Hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. A set of components (e.g., one or more components) of the device 500 may perform one or more functions described as being performed by another set of components of the device 500.

### INDUSTRIAL APPLICABILITY

Implementations described herein may be used with any machine that includes a controller and a perception sensor system that includes a plurality of sensors, such as any machine that utilizes an implement and linkage, such as a wheel loader that includes an implement and linkage to load, carry, and dump material (e.g., into a dump target).

A machine can include a plurality of sensors to detect a distance from the machine to a target (e.g., a dump target, such as a dump truck), such as to facilitate an automatic control operation (e.g., that controls a movement of the machine or an operation of an implement and a linkage of the machine, such as in relation to the target). For example, the plurality of sensors can capture and pass perception information that indicates individual detected distances to the target to a controller of the machine, and the controller thereby determines a distance (e.g., a representative distance based on the individual detected distances) to the target. However, in many cases, due to environmental factors, sensor factors, target factors, and/or machine factors, abilities of one or more sensors, of the plurality of sensors, to accurately detect individual distances to the target can be compromised. Consequently, the one or more sensors capture and pass erroneously detected distances to the controller of the machine, which reduces a likelihood of the controller determining an accurate distance to the target (e.g., because the distance to the target is based, at least in part, on the erroneously detected distances). This can result in the machine unintentionally contacting the target, such as due to a miscalculation of a stopping distance or of a position of an implement and a linkage of the machine with respect to the target. This, in turn, causes damage (e.g., dents, cracks, or other types of structural deformations) to the implement and the linkage, the machine, and the target, which impacts a performance, as well as reduces an operable life, of the implement and the linkage, the machine, and the target.

In some implementations, a controller of a machine may determine a current distance to a target based on validating perception information obtained by a perception sensor system of the machine that includes a plurality of sensors. For example, the controller may obtain the perception information, which includes respective perception data captured by the plurality of sensors, from the perception system. The controller then, based on a previously determined distance to the target (e.g., that was determined by the controller) and/or machine information (e.g., that indicates a position of an implement and a linkage of the machine and/or a steering angle of the machine) determines validation information associated with the perception information. The validation information indicates, for each sensor of the plurality of sensors, whether perception data that is captured by the sensor is valid (e.g., is sufficiently accurate to be used as a basis for determining the current distance to the target).

To determine the validity information, the controller may determine, for perception data, of the perception information that is captured by a sensor, a perceived distance to the target (e.g., as perceived by the sensor that captured the perception data). The controller may determine that the perception data is valid when the perceived distance to the target is sufficiently similar to the previously determined distance to the target, a previously determined (e.g., by the sensor) perceived distance to the target, and/or one or more other perceived distances to the target (e.g., determined based on other perception data, of the perception information, that is captured, respectively, by one or more other sensors of the plurality of sensors). In some cases,, the controller may determine that the perception data is valid by determining (e.g., based on the position of the implement and the linkage) that the field of view of the sensor is not obstructed (e.g., by the implement and the linkage), by determining that perception data is fresh, and/or by determining that the perception data is associated with a projected path of the machine (e.g., that is based on the steering angle of the machine).

Accordingly, the controller selects a portion of the perception information, which includes perception data that the validity information indicates is valid, and determines the current distance to the target based on the portion of the perception information (and not based on a portion of the perception information that includes perception data that the validity information indicates is not valid). For example, the controller processes the portion of the perception information (e.g. using an analysis technique that uses a Kalman filter, or another analysis technique) to determine the current distance to the target. Accordingly, the current distance to the target is a representative distance to the target of the plurality of sensors, where the representative distance is an aggregation (e.g., an average, or another type of aggregation) of distances associated with valid perception data captured by the plurality of sensors.

In this way, the controller prevents use of perception data that is not valid (e.g., that is not likely to be accurate), such as perception data captured by a malfunctioning, obstructed, or incorrectly positioned sensor, in determining the current distance to the target. Thus, the controller, by only using perception data that is valid (e.g., that is likely to be accurate), is more likely to accurately determine the current distance to the target. This thereby reduces a likelihood of the machine unintentionally contacting the target, such as due to a miscalculation of a stopping distance or of an implement and linkage position with respect to the target. Accordingly, in many cases, damage (e.g., dents, cracks, or other types of structural deformations) to the implement and the linkage, the machine, and the target is prevented, which improves a performance of, as well as increases an operable life of, the implement and the linkage, the machine, and the target.

What is claimed is:

1. A machine comprising:
an implement and a linkage;
a perception sensor system that includes a plurality of sensors;
a machine sensor system that includes a plurality of other sensors; and
a controller configured to:
identify a previously determined distance to a target;
obtain machine information from the machine sensor system;
determine, based on the machine information, a position of the implement and the linkage and a steering angle of the machine;
obtain perception information from the perception sensor system,
wherein the perception information includes respective perception data captured by the plurality of sensors;
determine, based on at least one of the previously determined distance to the target, the position of the implement and the linkage, or the steering angle of the machine, validity information associated with the perception information;
select, based on the validity information, a portion of the perception information; and
determine, based on the portion of the perception information, a current distance to the target.

2. The machine of claim 1, wherein the validity information indicates, for each sensor of the plurality of sensors, whether perception data that is captured by the sensor is valid.

3. The machine of claim 1, wherein the controller, to determine the validity information, is configured to:
identify perception data, of the perception information, that is captured by a sensor of the plurality of sensors;
determine, based on the perception data, a perceived distance to the target;
determine a distance difference between the perceived distance and the previously determined distance; and
determine, based on the distance difference, whether the perception data is valid.

4. The machine of claim 1, wherein the controller, to determine the validity information, is configured to:
identify perception data, of the perception information, that is captured by a sensor of the plurality of sensors;
determine, based on the perception data, a perceived distance to the target;
identify a previously determined perceived distance to the target that was determined based on previously captured perception data by the sensor;
determine a distance difference between the perceived distance and the previously determined perceived distance; and
determine, based on the distance difference, whether the perception data is valid.

5. The machine of claim 1, wherein the controller, to determine the validity information, is configured to:
identify perception data, of the perception information, that is captured by a sensor of the plurality of sensors;
determine, based on the perception data, a perceived distance to the target;
determine, based on other perception data, of the perception information, that is captured, respectively, by one or more other sensors of the plurality of sensors, one or more other perceived distances to the target;
determine respective distance differences between the perceived distance and the one or more other perceived distances; and
determine, based on the respective distance differences, whether the perception data is valid.

6. The machine of claim 1, wherein the controller, to determine the validity information, is configured to:
identify perception data, of the perception information, that is captured by a sensor of the plurality of sensors;
determine, based on the position of the implement and the linkage, whether a field of view of the sensor is obstructed by the implement and the linkage; and
determine, based on determining whether the field of view of the sensor is obstructed, whether the perception data is valid.

7. The machine of claim 1, wherein the controller, to determine the validity information, is configured to:
identify perception data, of the perception information, that is captured by a sensor of the plurality of sensors;
identify a first instant in time associated with the previously determined distance;
identify a second instant in time associated with the perception data;
determine whether the second instant in time occurred after the first instant in time; and
determined, based on determining whether the second instant in time occurred after the first instant in time, whether the perception data is valid.

8. The machine of claim 1, wherein the controller, to determine the validity information, is configured to:
identify perception data, of the perception information, that is captured by a sensor of the plurality of sensors;
determine, based on the steering angle of the machine, a projected path of the machine;
determine whether the perception data is associated with the projected path; and
determine, based on determining whether the perception data is associated with the projected path, whether the perception data is valid.

9. A controller of a machine, comprising:
one or more memories; and
one or more processors, coupled to the one or more memories, configured to:
identify a previously determined distance to a target;
obtain machine information from a machine sensor system of the machine;
obtain perception information from a perception sensor system of the machine that includes a plurality of sensors;
determine, based on at least one of the previously determined distance to the target or the machine information, validity information associated with the perception information;
select, based on the validity information, a portion of the perception information; and
determine, based on the portion of the perception information, a current distance to the target.

10. The controller of claim 9, wherein the one or more processors, to determine the validity information, are configured to:
determine, based on perception data, of the perception information, that is captured by a sensor of the plurality of sensors, a perceived distance to the target;
determine a distance difference between the perceived distance and the previously determined distance; and
determine, based on the distance difference, whether the perception data is valid.

11. The controller of claim 9, wherein the one or more processors, to determine the validity information, are configured to:
determine, based on perception data, of the perception information, that is captured by a sensor of the plurality of sensors, a perceived distance to the target;
identify a previously determined perceived distance to the target that was determined based on previously captured perception data by the sensor;
determine a distance difference between the perceived distance and the previously determined perceived distance; and
determine, based on the distance difference, whether the perception data is valid.

12. The controller of claim 9, wherein the one or more processors, to determine the validity information, are configured to:
determine, based on perception data, of the perception information, that is captured by a sensor of the plurality of sensors, a perceived distance to the target;
determine, based on other perception data, of the perception information, that is captured, respectively, by one or more other sensors of the plurality of sensors, one or more other perceived distances to the target;
determine respective distance differences between the perceived distance and the one or more other perceived distances; and
determine, based on the respective distance differences, whether the perception data is valid.

13. The controller of claim 9, wherein the one or more processors, to determine the validity information, are configured to:
identify perception data, of the perception information, that is captured by a sensor of the plurality of sensors;
determine, based on the machine information, whether a field of view of the sensor is obstructed; and
determine, based on determining whether the field of view of the sensor is obstructed, whether the perception data is valid.

14. The controller of claim 9, wherein the one or more processors, to determine the validity information, are configured to:
identify perception data, of the perception information, that is captured by a sensor of the plurality of sensors;
determine whether a second instant in time associated with the perception data occurred after a first instant in time associated with the previously determined distance; and
determined, based on determining whether the second instant in time occurred after the first instant in time, whether the perception data is valid.

15. The controller of claim 9, wherein the one or more processors, to determine the validity information, are configured to:
identify perception data, of the perception information, that is captured by a sensor of the plurality of sensors;
determine, based on the machine information, whether the perception data is associated with a projected path of the machine; and
determine, based on determining whether the perception data is associated with the projected path, whether the perception data is valid.

16. A method, comprising:
obtaining, by a controller of a machine, perception information from a perception sensor system of the machine that includes a plurality of sensors,
wherein the perception information includes respective perception data captured by the plurality of sensors;
determining, by the controller, validity information associated with the perception information;
selecting, by the controller, based on the validity information, a portion of the perception information; and
determining, by the controller, based on the portion of the perception information, a current distance to a target.

17. The method of claim 16, further comprising:
determining, based on perception data, of the perception information, that is captured by a sensor of the plurality of sensors, a perceived distance to the target;
determining distance difference information, which indicates at least one of:
a first distance difference between the perceived distance and a previously determined distance to the target,
a second distance difference between the perceived distance and a previously determined perceived distance to the target that was determined based on previously captured perception data by the sensor, or
respective third distance differences between the perceived distance and one or more other perceived distances to the target that are determined based on other perception data, of the perception information, that is captured, respectively, by one or more other sensors of the plurality of sensors; and
determining, based on the distance difference information, whether the perception data is valid.

18. The method of claim 16, further comprising:
identifying perception data, of the perception information, that is captured by a sensor of the plurality of sensors;
determining whether a field of view of the sensor is obstructed; and
determining, based on determining whether the field of view of the sensor is obstructed, whether the perception data is valid.

19. The method of claim 16, further comprising:
identifying perception data, of the perception information, that is captured by a sensor of the plurality of sensors; and
determining, based on an instant in time associated with the perception data, whether the perception data is valid.

20. The method of claim 16, further comprising:
identifying perception data, of the perception information, that is captured by a sensor of the plurality of sensors;
determining whether the perception data is associated with a projected path of the machine; and
determining, based on determining whether the perception data is associated with the projected path, whether the perception data is valid.
